(19) United States
(12) Patent Application Publication
(10) Pub. No.: US 2011/0194205 A1
(43) Pub. Date: Aug. 11, 2011

(54) METHOD AND APPARATUS FOR MANAGING DEFECTS OF RECORDING MEDIUM

(75) Inventors: Hwa-jun Kim, Hwaseong-si (KR); Jae-deog Cho, Suwon-si (KR)

(73) Assignee: SAMSUNG ELECTRONICS CO., LTD., Suwon-si (KR)

(21) Appl. No.: 13/024,361

(22) Filed: Feb. 10, 2011

(30) Foreign Application Priority Data
Feb. 10, 2010 (KR) 10-2010-0012405

(51) Int. Cl. G11B 5/09

(52) U.S. Cl. 360/53; G9B/5.033

(57) ABSTRACT

A method of managing defects of a recording medium of a data storage device includes performing a quality test related to occurrence of errors for each data sector in the recording medium; classifying a quality of each data sector according to evaluation criteria corresponding to quality classifications based on the quality test; determining a number of data sectors in each quality classification; and defect-processing the data sectors of the quality classifications that range from a lowest quality classification to a highest quality classification within a defect management limitation of the data storage device.

### CROSS-REFERENCE TO RELATED APPLICATIONS

A claim of priority is made to Korean Patent Application No. 10-2010-0012405, filed on Feb. 10, 2010, in the Korean Intellectual Property Office, the disclosure of which is hereby incorporated by reference.

### BACKGROUND

Embodiments of the inventive concept relate to a method and an apparatus for managing defects of a recording medium, and more particularly, to a method and an apparatus for adaptively managing defects based on the defect management limitation of a data storage device.

A disc drive is a data storage device that stores information by magnetizing the surface of a disc. Defects may occur in portions or sectors of the disc, which is a recording medium. Thus, technology for efficiently managing such defect is needed.

### SUMMARY

Embodiments of the inventive concept provide a method and a device for managing defects of a recording medium adaptively in consideration of a defect management limitation and a quality of the defect management of a data storage device.

The inventive concept also provides a data storage device for adaptively managing defects in data sectors of a recording medium in consideration of a defect management limitation and a quality of the defect management of the data storage device.

The inventive concept also provides a computer readable storage medium having recorded thereon a program code for managing defects of the recording medium adaptively in consideration of a defect management limitation and a quality of the defect management of a data storage device.

According to an aspect of the inventive concept, there is provided a method of managing defects of a recording medium of a data storage device. The method includes performing a quality test related to occurrence of errors for each data sector in the recording medium; classifying a quality of each data sector according to multiple evaluation criteria corresponding to multiple quality classifications based on the quality test; determining a number of data sectors in each quality classification of the multiple quality classifications; and defect-processing the data sectors in the quality classifications that range from a lowest quality classification to a highest quality classification within a defect management limitation of the data storage device.

The quality test may include detecting a number of error-corrected error correction code (ECC) symbols, indicating that errors occurred and have been corrected, from ECC symbols when data is read from the recording medium in which a test signal is written in each data sector.

The quality test may include detecting a number of detection events, in which a magnitude of a signal reproduced from the recording medium on which a test signal is written is less than a threshold value, in each data sector. The signal reproduced from the recording medium may include a signal indicating an amount by which the signal is amplified by a variable gain amplifier (VGA).

The quality test may include detecting the number of detection events, in which an amount of gain variation of a VGA for amplifying the signal detected from the recording medium in which a test signal is written exceeds a threshold value, in each data sector. The test signal may include a signal having a 2T pattern.

The evaluation criteria may include an evaluation criterion for determining defective data sectors having the lowest quality classification and at least one evaluation criterion for determining potentially defective data sectors.

The method of managing defects of a recording medium may further include determining the data storage device is a defective data storage device when a number of data sectors belonging to the lowest quality classification exceeds the defect management limitation of the data storage device.

The defect-processing the data sectors may include comparing the number of data sectors belonging to a corresponding quality classification in a sequence of quality classifications with the defect management limitation; selecting a quality classification including the number of data sectors that do not exceed the defect management limitation and are closest to the defect management limitation; and defect-processing the data sectors belonging to the selected quality classification. The defect-processing of the data sectors belonging to the selected quality classification may include screen processing of data sectors so that logical block addresses are not allocated to the data sectors belonging to the selected quality classification.

According to another aspect of the inventive concept, there is provided a data storage device including a recording medium in which information is stored, a media interface for writing to or reading from the recording medium by accessing the recording medium, and a processor. The recording medium includes multiple data sectors. The processor performs a quality test related to occurrence of errors for each data sector in the recording medium by controlling the media interface, classifies a quality of each data sector according to multiple evaluation criteria corresponding to multiple quality classifications based on the quality test, determines a number of data sectors in each quality classification of the multiple quality classifications, and defect-processes the data sectors in the quality classifications that range from a lowest quality classification to a highest quality classification within a defect management limitation of the data storage device.

If the number of data sectors belonging to lowest quality classification exceeds the defect management limitation allowable in the data storage device, the processor may determine the data storage device as a defective data storage device.

The processor may compare the number of data sectors belonging to a corresponding quality classification in a sequence of quality classifications with the defect management limitation, select a quality classification including the number of data sectors that do not exceed the defect management limitation and are closest to the defect management limitation, and determine that the data sectors belonging to the selected quality classification are defective.

The processor may include an error correction code (ECC) processing unit for detecting error-corrected ECC symbols, indicating that errors occurred and have been corrected, from ECC symbols belonging to information read from the recording medium and generating information about the number of error-corrected ECC symbols for each data sector; a sector quality classification unit for classifying the quality of data sectors according to the evaluation criteria based on the information about the number of error-corrected ECC symbols for each data sector; a counting unit for determining the number of data sectors in each quality classification of the multiple quality classifications based on quality classifications evaluated by the sector quality classification unit; a defect sector determination unit for comparing the number of data sectors in each of the quality classifications with the defect management limitation and determining as defective data sectors belonging to a quality classification including the number of data sectors that do not exceed the defect management limitation and are closest to the defect management limitation; and a defect controller for controlling defects so that logical block addresses are not allocated to the defective data sectors.

The processor may include an abnormal level detection unit for detecting a magnitude of a signal reproduced from the recording medium and calculating a number of detection events in which the magnitude of the detected signal is less than a threshold value in each data sector; a sector quality classification unit for classifying the quality of data sectors according to the evaluation criteria based on the number of detection events calculated by the abnormal level detection unit; a counting unit for determining the number of data sectors in each quality classification of the quality classifications based on quality classifications evaluated by the sector quality classification unit; a defect sector determination unit for comparing the number of data sectors in each of the quality classifications with the defect management limitation and determining as defective data sectors belonging to a quality classification including the number of data sectors that do not exceed the defect management limitation and are closest to the defect management limitation; and a defect controller for controlling defects so that logical block addresses are not allocated to the defective data sectors.

The processor may include an abnormal gain variation detection unit for detecting an amount of gain variation of a variable gain amplifier (VGA) for varying a gain of a signal reproduced from the recording medium to amplify the signal to a desired level and calculating a number of detection events in which the amount of gain variation detected by the abnormal gain variation detection unit exceeds a threshold value in each data sector; a sector quality classification unit for classifying the quality of data sectors according to the evaluation criteria based on the number of detection events calculated by the abnormal gain variation detection unit; a counting unit for determining the number of data sectors in each quality classification of the quality classifications based on quality classifications evaluated by the sector quality classification unit; a defect sector determination unit for comparing the number of data sectors in each of the quality classifications with the defect management limitation and determining as defective data sectors belonging to a quality classification including the number of data sectors that do not exceed the defect management limitation and are closest to the defect management limitation; and a defect controller for controlling defects so that logical block addresses are not allocated to the defective data sectors.

The recording medium may include a disc.

According to another aspect of the inventive concept, there is provided a computer readable storage medium storing program code for managing defects of a recording medium. The computer readable storage medium includes performing code for performing a quality test related to occurrence of errors for each data sector in the recording medium; classifying code for classifying a quality of each data sector according to multiple criteria corresponding to multiple quality classifications based on the quality test; determining code for determining a number of data sectors in each quality classification of the quality classifications; and defect-processing code for defect-processing the data sectors the quality classifications that range from a lowest quality classification to a highest quality classification within a defect management limitation of the data storage device.

### BRIEF DESCRIPTION OF THE DRAWINGS

The embodiments of the inventive concept will be described with reference to the attached drawings, in which:

FIG. 1 is a block diagram of a structure of a data storage device, according to an embodiment of the inventive concept;

FIG. 2 is a block diagram of a software operating system of the data storage device of FIG. 1;

FIG. 3 is a plan view of a head disc assembly of a disc drive, according to an embodiment of the inventive concept;

FIG. 4 is a block diagram of an electrical structure of the disc drive of FIG. 3, according to an embodiment of the inventive concept;

FIG. 5 illustrates a structure of a sector of one track of a disc that is a recording medium, according to an embodiment of the inventive concept;

FIG. 6 illustrates a structure of a servo information field of the sector of FIG. 5, according to an embodiment of the inventive concept;

FIG. 7 is a block diagram of a structure of an apparatus for managing defects of a recording medium, according to an embodiment of the inventive concept;

FIG. 8 is a block diagram of a structure of an apparatus for managing defects of a recording medium, according to another embodiment of the inventive concept;

FIG. 9 is a block diagram of a structure of an apparatus for managing defects of a recording medium, according to another embodiment of the inventive concept;

FIG. 10 is a flowchart illustrating a method of managing defects of a recording medium, according to an embodiment of the inventive concept;

FIG. 11 is a flowchart illustrating a method of managing defects of a recording medium, according to another embodiment of the inventive concept;

FIG. 12 is a flowchart illustrating a method of managing defects of a recording medium, according to another embodiment of the inventive concept;

FIG. 13 is a flowchart illustrating a method of managing defects of a recording medium, according to another embodiment of the inventive concept;

FIG. 14 is a graph showing distribution of the number of error-corrected ECC symbols for each sector in an ECC quality test, according to an embodiment of the inventive concept; and

FIG. 15 illustrates the concept of defect management by classifying the quality of defective data sectors, for explaining a method of managing defects of a recording medium according to an embodiment of the inventive concept.

### DETAILED DESCRIPTION OF THE EMBODIMENTS

The invention concept will now be described more fully with reference to the accompanying drawings, in which exemplary embodiments of the inventive concept are shown. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description. In the drawings, thicknesses and other dimensions may be exaggerated for clarity.

A disc drive, which is an example of a data storage device, stores information in at least one disc by magnetizing the surface of the disc. Defects may be present in the disc, which may be classified generally into raw material defects and process defects. The concept of managing the defects is described below.

A raw material defect is a phenomenon in which the disc is not magnetized normally due to a physical defect on the surface of the disc. Ideally, when all areas of the disc are uniform, the raw material defect does not affect the disc. In actuality, the physical defect occurs in portions of the disc even though the surface of the disc undergoes precise processing. Thus, areas that are not normally magnetized are generated, and the raw material defect occurs in the areas that are not normally magnetized. In a position where the raw material defect occurs, the disc is not normally magnetized when information is written to the disc. Thus, incorrect or inaccurate information may be written to or read from the disc. A process defect is a phenomenon in which information cannot be precisely written to or read from portions where interference between tracks is severe. The interference may be due to lowering of the degree of precision or occurrence of a disturbance. Processing for preventing data from being written to or read from areas in which such defects occur is called defect management.

The storage capacity of a data storage device is determined to account for occurrence of defects when the data storage device is designed. In other words, portions of the storage capacity of the data storage device are allocated for defect management. Accordingly, the scope of the capacity allocated for managing the occurrence of defects is referred to as the defect management limitation.

Embodiments of the inventive concept are directed to ways to identify a defective data sector in which an error occurs, as well as a data sector that has a high probability that an error may occur, as a defect area considering the defect management limitation, and to process the defect area.

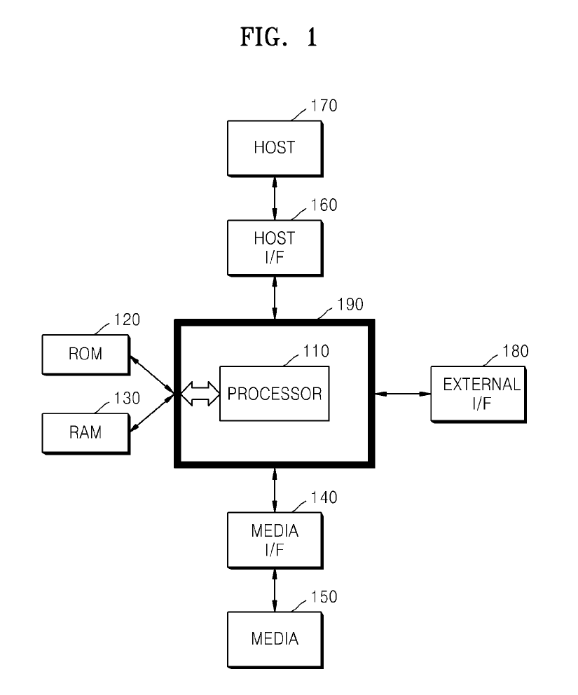

FIG. 1 is a block diagram of a structure of a data storage device, according to an embodiment of the inventive concept. Referring to FIG. 1, the data storage device includes a processor 110, a read only memory (ROM) 120, a random access memory (RAM) 130, a media interface (I/F) 140, media 150, a host I/F 160, a host 170, an external I/F 180, and a bus 190.

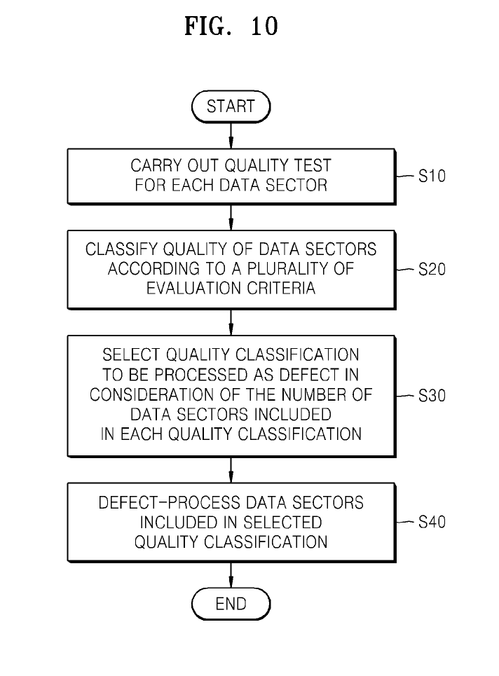

The processor 110 interprets commands and controls elements of the data storage device based on the interpretation of the commands. The processor 110 includes a code object management unit (not shown), and loads a code object stored in the media 150 into the RAM 130 using the code object management unit. The processor 110 loads into the RAM 130 code objects for performing methods of managing defects of a recording medium, examples of which are illustrated in FIGS. 10 through 13, in a defect test mode.

The processor 110 executes a task for detecting and managing defects using the code objects loaded into the RAM 130, based on the methods illustrated in FIGS. 10 through 13, and stores information for detecting and managing the defect in the media 150 or the ROM 120. Examples of the information for detecting and managing defects include critical information for performing a quality test related to the occurrence of errors, information about criteria for classifying the quality of data sectors, defect management limitation information, and defect list information, and the like. Methods of detecting and managing defects using the processor 110 will be described in detail with reference to FIGS. 10 through 13, below.

Program codes and data for operating the data storage device are stored in the ROM 120 or the media 150. The program codes and data stored in the ROM 120 or the media 150 are loaded into the RAM 130 under control of the processor 110.

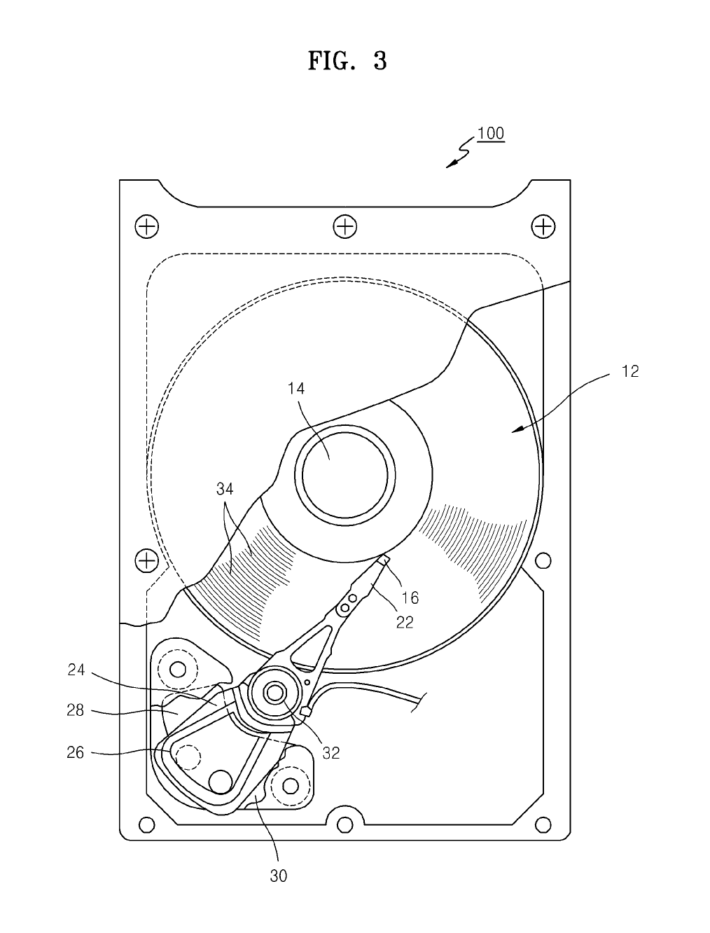

The media 150 may include a disc, for example, as a main storage medium of the data storage device. For example, the data storage device may be a disc drive, as shown in FIG. 3.

In particular, FIG. 3 is a plan view of a head disc assembly 100 of the disc drive, according to an embodiment of the inventive concept. Referring to FIG. 3, the head disc assembly 100 includes at least one disc 12 that is rotated by a spindle motor (SPM) 14. The disc drive also includes a magnetic head 16 adjacent to the surface of the disc 12.

The magnetic head 16 may read or write information from or to the disc 12 by sensing a magnetic field of the disc 12 or by magnetizing the disc 12, respectively. The magnetic head 16 is generally associated with the surface of the disc 12. Although a single magnetic head 16 is shown, it is understood that the magnetic head 16 includes a separate writing head, referred to as a writer, for magnetizing the disc 12, and a reading head, referred to as a reader, for sensing the magnetic field of the disc 12. The reading head includes a magneto-resistive (MR) element. The magnetic head 16 is also referred to as a magnetic head or a transducer.

The magnetic head 16 may be integrated with a slider 20. The slider 20 generates an air bearing between the magnetic head 16 and the surface of the disc 12. The slider 20 is coupled to a head gimbal assembly (HGA) 22, which is attached to an actuator arm 24 including a voice coil 26. The voice coil 26 is disposed adjacent to a magnetic assembly 28 to define a voice coil motor (VCM) 30. A current that flows through the voice coil 26 generates a torque for rotating the actuator arm 24 about a bearing assembly 32. Rotation of the actuator arm 24 moves the magnetic head 16 across the surface of the disc 12. Information is generally stored in ring-shaped tracks 34 of the disc 12. Each of the ring-shaped tracks 34 generally includes multiple data sectors.

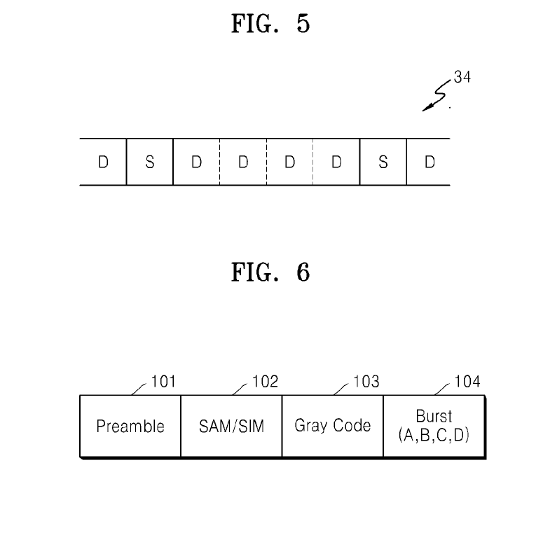

FIG. 5 illustrates a structure of a representative sector of one track 34 of a disc that is a recording medium, according to an embodiment of the inventive concept. Referring to FIG. 5, the track 34 includes multiple servo information fields S in which servo information is written, and multiple data sectors D in which data are stored. Multiple data sectors D may be interposed between the servo information fields S. Alternatively, a single data sector D may be interposed between the servo information fields S.

FIG. 6 illustrates a structure of a representative servo information field S of FIG. 5, according to an embodiment of the inventive concept. Signals illustrated in FIG. 6 are written to the servo information field S. Referring to FIG. 6, a preamble 101, a servo synchronization mark signal 102, a gray code 103, and a burst signal 104 are the signals written to the servo information field S.

The preamble 101 provides clock synchronization when servo information is read and provides a predetermined timing margin by a gap between the preamble 101 and a front portion of the data sector. The preamble 101 is used to determine a gain of an automatic gain control (AGC) circuit.

The servo synchronization mark signal 102 includes a servo address mark (SAM) and a servo index mark (SIM). The SAM is a signal that indicates the start of a sector, and the SIM is a signal that indicates the start of a first sector.

The gray code 103 provides track information, and the burst signal 104 is used to control the magnetic head 16 to follow a central portion of the track 34. The burst signal 104 may include four patterns, namely patterns A, B, C and D, and generates a position error signal (PES) used to control following the track 34 by combining the four burst patterns, patterns A, B, C and D.

Referring again to FIG. 3, a logical block address is allocated to a write area of the disc 12. The logical block address of the disc drive is transformed into cylinder/head/sector information to designate the write area of the disc 12. The disc 12 includes a maintenance cylinder area that a user is not able to access and a user data area that a user is able to access. The maintenance cylinder area is also referred to as a system area. A defect list, including data sector information regarding a data sector in which a defect occurs, is stored in the maintenance cylinder area.

The magnetic head 16 is moved across the surface of the disc 12 to read or write information stored in any of the tracks 34. Multiple code objects for implementing various functions of the disc drive may be stored in the disc 12. As an example, a code object for performing a function of an MP3 player, a code object for performing a navigation function, a code object for performing various video games, or the like may be stored in the disc 12.

Referring again to FIG. 1, the media I/F 140 writes or reads information when the processor 110 accesses the media 150. The media I/F 140 in the data storage device implemented as the disc drive includes a servo circuit for controlling the head disc assembly 100 and a read/write channel circuit for performing signal processing for data reading/data writing.

The host I/F 160 enables transmission and/or reception of data to or from the host 170, such as a personal computer (PC) or the like. For example, various standard interfaces, such as a serial advanced technology attachment (SATA) interface, a parallel advanced technology attachment (PATA) interface, a universal serial bus (USB) interface, and the like may be used as the host PF 160.

The external I/F 180 enables transmission and/or reception of data to or from an external device (not shown) via an input/output terminal (not shown) installed in the data storage device. For example, various standard interfaces, such as an accelerated graphics port (AGP) interface, a USB interface, an IEEE1394 interface, a personal computer memory card international association (PCMCIA) interface, a local area network (LAN) interface, a Bluetooth interface, a high definition multimedia interface (HDMI), a programmable communication interface (PCI), an industry standard architecture (ISA) interface, a peripheral component interconnect-express (PCI-E) interface, an express card interface, a SATA interface, a PATA interface, a serial interface, and the like may be used as the external I/F 180. The bus 190 enables transmission information among elements of the data storage device.

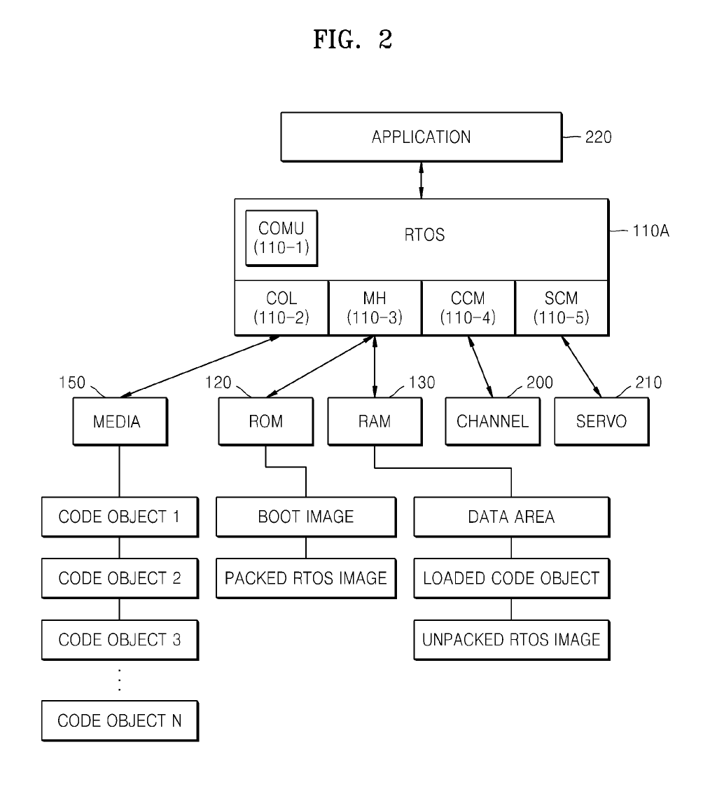

A software operating system of the disc drive, which is an example of the data storage device, will now be described with reference to FIG. 2.

FIG. 2 is a block diagram of a software operating system of the data storage device of FIG. 1, according to an embodiment of the inventive concept. Referring to FIG. 2, multiple code objects 1, 2, 3, . . . N are stored in the media 150 of a disc drive. A boot image and a packed real time operating system (RTOS) image are stored in the ROM 120.

For example, the code objects 1, 2, 3, . . . N may be stored in a disc, which is the media 150 of the disc drive. The code objects 1, 2, 3, . . . N may include code objects related to various functions that are extendable to the disc drive, as well as code objects for operating the disc drive. In particular, code objects for performing the methods of managing a defect of a recording medium, which are illustrated in FIGS. 10 through 13, are stored in the disc. The code objects for performing the methods illustrated in FIGS. 10 through 13 may also be stored in the ROM 120 instead of the disc, which is the media 150. Code objects for performing various functions, such as a function of an MP3 player, a navigation function, a video game function, and the like, may also be stored in the disc.

The boot image is read from the ROM 120 during a booting operation of the disc drive, and an unpacked RTOS image is loaded into the RAM 130. Code objects, which are stored in the media 150 of the disc drive, for operating the host I/F 160 and the external I/F 180, are loaded into the RAM 130. A data area in which data are to be stored is allocated in the RAM 130.

Circuits for performing signal processing for data reading/writing are installed in a channel unit 200. Circuits for controlling the head disc assembly 100 are installed in a servo circuit unit 210 to perform data reading/writing.

A RTOS 110A is a multi-program real time operating system, which may use a disc. The RTOS 110A performs real time multi-processing higher priority tasks in the foreground, and performs batch processing on lower priority tasks in the background. The RTOS 110A loads the code objects into the disc or unloads the code objects from the disc. The RTOS 110A manages a code object management unit (COMU) 110-1, a code object loader (COL) 110-2, a memory handler MH 110-3, a channel control module (CCM) 110-4, and a servo control module (SCM) 110-5, and performs tasks according to request commands. The RTOS 110A also manages application programs 220.

More particularly, the RTOS 110A loads the code objects for controlling the disc drive during a booting operation of the disc drive into the RAM 130. Thus, after the booting operation of the disc drive is performed, the disc drive may be operated using the code objects loaded into the RAM 130.

The COMU 110-1 stores position information regarding locations where the code objects 1, 2, 3, . . . N are written, transforms a virtual address into an actual address and performs arbitration of the bus 190. Also, information about priorities of the tasks that are being performed is stored in the COMU 110-1. The COMU 110-1 also manages task control block (TCB) information and stack information for performing the tasks regarding the code objects.

The COL 110-2 loads the code objects stored in the media 150 using the COMU 110-1, or unloads the code objects stored in the RAM 130 from the media 150. Thus, the COL 110-2 may load into the RAM 130 the code objects, which are stored in the media 150, for performing the methods of managing defects of a recording medium, examples of which are illustrated in FIGS. 10 through 13.

Thus, the RTOS 110A performs the methods of managing defects of a recording medium, which are illustrated in FIGS. 10 through 13 described below, using the code objects loaded into the RAM 130.

The MH 110-3 writes to or reads from the ROM 120 and the RAM 130. The CCM 110-4 performs channel control for performing signal processing for data reading/writing, and the SCM 110-5 performs servo control on a head disc assembly to perform data reading/writing.

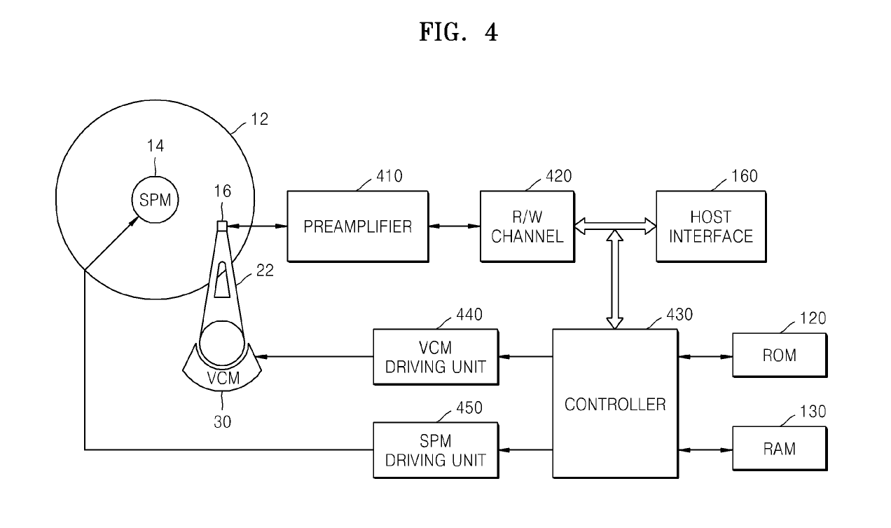

FIG. 4 is a block diagram of an electrical structure of the disc drive of FIG. 1, which is an example of the data storage device, according to an embodiment of the inventive concept. Referring to FIG. 4, the disc drive includes a preamplifier 410, a read/write (R/W) channel 420, a controller 430, a voice coil motor (VCM) driving unit 440, a spindle motor (SPM) driving unit 450, a ROM 120, a RAM 130, and a host I/F 160.

The controller 430 may be a digital signal processor (DSP), a microprocessor, a microcontroller, a processor, or the like. The controller 430 controls the R/W channel 420 to read information from the disc 12 or to write information to the disc 12 according to a command received from the host (e.g., host 170) via the host I/F 160.

The controller 430 is coupled to the VCM driving unit 440 for supplying a driving current used to drive the VCM 30. The controller 430 supplies a control signal to the VCM driving unit 440 to control movement of the magnetic head 16. The controller 430 is also coupled to the SPM driving unit 450 for supplying a driving current used to drive the SPM 14. When power is supplied to the disc drive, the controller 430 supplies a control signal to the SPM driving unit 450 to rotate the SPM 14 at a desired speed.

The controller 430 is coupled to the ROM 12 and the RAM 130, respectively. Firmware and control data for controlling the disc drive are stored in the ROM 120. Also, program codes and information for performing the methods of managing defects of a recording medium, examples of which are illustrated in FIGS. 10 through 13, are stored in the ROM 120. The program codes and information for performing the methods of managing defects of a recording medium may be stored in a maintenance cylinder area of the disc 12 instead of the ROM 120.

Operation of the disc drive is described below.

In a data read mode, the preamplifier 410 of the disc drive amplifies an electrical signal sensed by the magnetic head 16 from the disc 12. Then, a variable gain amplifier (VGA) (not shown) disposed at the R/W channel 420 automatically varies a gain of a signal output by the preamplifier 410 to reach a desired level and amplifies the signal. The amplified signal is converted into a digital signal, which is decoded so that data may be detected. The controller 430 performs error correction using a Reed-Solomon (RS) code, which is an error correction code (ECC) on the detected data, converts the data into stream data, and then transmits the stream data to the host 170 via the host I/F 160. In a defect test mode, the controller 430 may generate information about the number of ECC correction symbols indicating that errors occurred and have been corrected, from among ECC correction symbols included in information read from the disc 12, according to data sectors.

In a write mode, the disc drive receives data from the host 170 via the host I/F 160, adds the ECC correction symbols generated by the controller 430 due to the RS code, and encodes the data in a format of the write channel using the R/W channel 420. The disc drive then writes the data in the disc 12 via the magnetic head 16 using a write current amplified by the preamplifier 410.

A method of managing defects of a recording medium, according to an embodiment of the inventive concept, is described below.

The controller 430 loads the program codes and information for performing the methods of managing defects of a recording medium, which are stored in the ROM 120 and/or the disc 12, into the RAM 130. The controller 430 controls elements to perform the methods of managing defects of a recording medium, examples of which are illustrated in FIGS. 10 through 13, using the program codes and information loaded into the RAM 130.

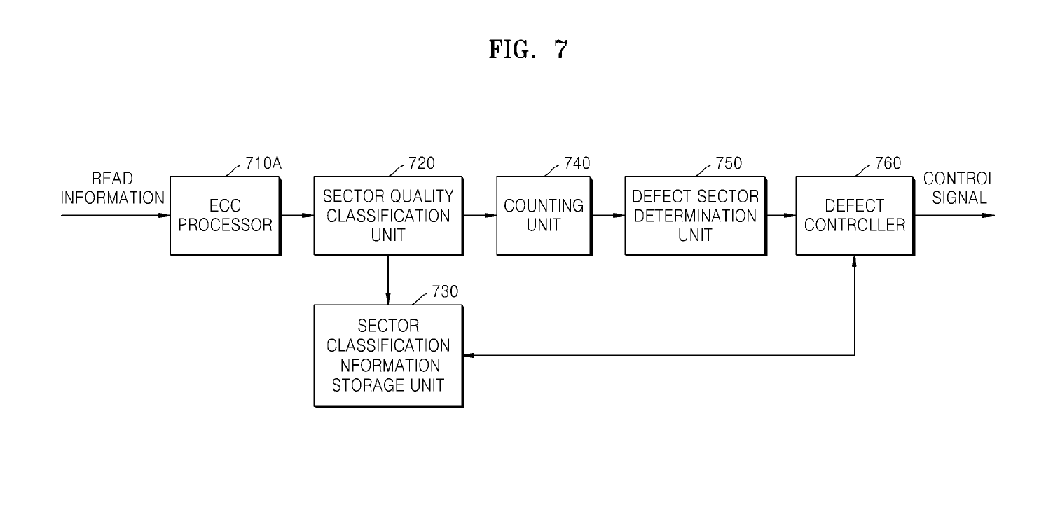

FIG. 7 is a block diagram of a structure of an apparatus for managing defects of a recording medium, according to an embodiment of the inventive concept. Referring to FIG. 7, the apparatus for managing defects of a recording medium may be included in the processor 110 of the data storage device of FIG. 1 or the controller 430 of FIG. 4, and/or may also be a separate circuit, according to design requirements, application specific implementations and other circumstances.

The apparatus for managing defects of a recording medium, which is illustrated in FIG. 7, according to the present embodiment of the inventive concept, includes an ECC processor 710A, a sector quality classification unit 720, a sector classification information storage unit 730, a counting unit 740, a defect sector determination unit 750, and a defect controller 760.

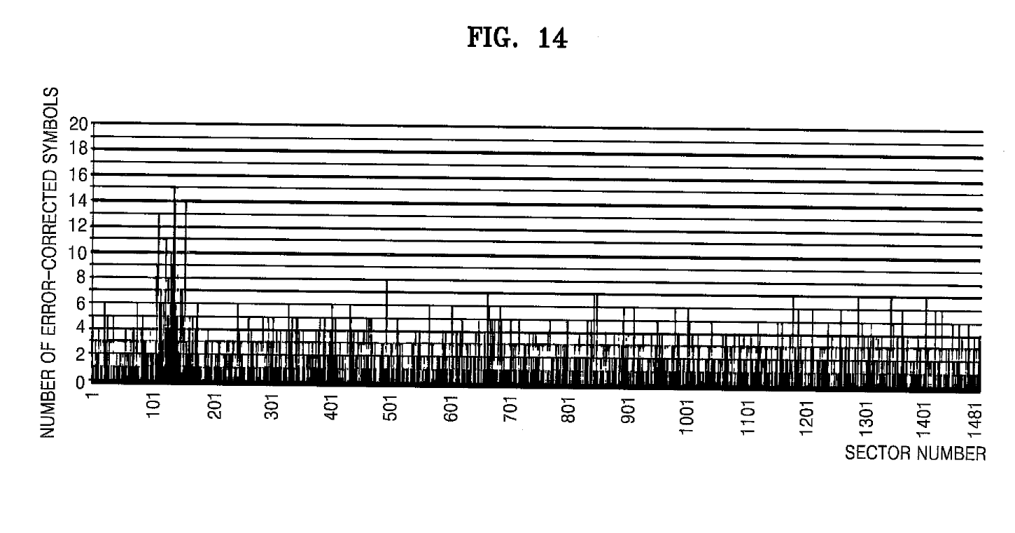

Data processing for defect management is performed after test information or a test signal is written to the recording medium to detect the defect of the recording medium. The ECC processor 710A detects error-corrected ECC symbols, indicating that errors occurred and have been corrected, from ECC symbols included in information read from the recording medium in which test information is written, in track units by performing an ECC scan operation. The ECC processor 710A generates information about the number of the error-corrected ECC symbols of each data sector. For example, the ECC processor 710A may detect ECC symbols indicating that errors occurred from ECC symbols using an RS decoder, and may generate error-corrected ECC symbols for correcting the ECC symbols indicating that errors occurred. Thus, the number of error-corrected ECC symbols in each data sector may be counted to obtain information about the number of error-corrected ECC symbols in each data sector. An example of the distribution of the calculated number of error-corrected ECC symbols for each data sector is shown in FIG. 14.

The sector quality classification unit 720 classifies the quality of data sectors according to evaluation criteria based on the error-corrected ECC symbols. The evaluation criteria may include an absolute evaluation criterion for determining defective data sectors having the lowest quality and/or a relative evaluation criterion for determining potentially defective data sectors including defective data sectors. The relative evaluation criterion may be subdivided into one or more criteria. For example, the quality of data sectors may be classified according to four quality classifications when the quality of data sectors is evaluated according to three evaluation criteria, for example, including an absolute evaluation criterion, a first relative evaluation criterion and a second relative evaluation criterion.

More particularly, data sectors having first (lowest) quality classification Class_1 indicative of a defective data sector may be determined according to the absolute evaluation criterion. Data sectors having a second quality classification Class_2 including potentially defective data sectors in a first range may be determined according to the first relative evaluation criterion. In this regard, the second quality classification Class_2 includes the first quality classification Class_1. Data sectors having a third quality classification Class_3 including potentially defective data sectors in a second range may be determined according to the second relative evaluation criterion. In this regard, the third quality classification Class_3 includes the first quality classification Class_1 and the second quality classification Class_2. Data sectors that do not belong to any of the first quality classification Class_1, the second quality classification Class_2, or the third quality classification Class_3 may be classified in a forth classification as good or not defective data sectors.

For example, the sector quality classification unit 720 may determine that a data sector in which the number of error-corrected ECC symbols exceeds a first threshold value TH(1), which is the absolute evaluation criterion, is in the first quality classification Class_1. In addition, the sector quality classification unit 720 may determine that a data sector in which the number of error-corrected ECC symbols exceeds a second threshold value TH(2), which is the first relative evaluation criterion, is in the second quality classification Class_2, and that a data sector in which the number of error-corrected ECC symbols exceeds a third threshold value TH(3), which is the second relative evaluation criterion, is in the third quality classification Class_3. The sector quality classification unit 720 determines that a data sector in which the number of error-corrected ECC symbols does not exceed the third threshold value TH(3) is in a good or not defective quality classification. Thus, in this example, the relative sizes of the first, second and third threshold values are TH(1)>TH(2)>TH(3).

In the present embodiment of the inventive concept, the qualities of the data sectors are classified according to three evaluation criteria. However, the inventive concept is not limited thereto, and qualities of the data sectors may be been classified according to any number of evaluation criteria, such as two evaluation criteria or four or more evaluation criteria.

The sector classification information storage unit 730 stores information about data sectors that belong to quality classifications. For example, the sector classification information storage unit 730 may store information about one data sector and matching information about the quality classification of the data sector.

The counting unit 740 calculates the number of data sectors that belong to quality classifications in the entire area of the recording medium by accumulating the number of data sectors. The number of data sectors that belong to a good quality classification does not need to be calculated. For example, when the qualities of data sectors are classified according to three evaluation criteria, the counting unit 740 calculates the number EC_1 of data sectors that belong to the first quality classification Class_1, the number EC_2 of data sectors that belong to the second quality classification Class_2, and the number EC_3 of data sectors that belong to the third quality classification Class_3. In this regard, EC_1=EC_2=EC_3.

The defect sector determination unit 750 compares the number of data sectors in the quality classifications with a limitation DET of defect management of the data storage device. Based on the comparisons, the defect sector determination unit 750 determines data sectors that belong to quality classifications, including the number of data sectors that do not exceed the limitation DET of defect management and are closest to the limitation DET of defect management, as defective data sectors.

For example, when the quality of data sectors is classified according to three evaluation criteria, the defect sector determination unit 750 makes the following determinations. The defect sector determination unit 750 compares the number EC_1 of data sectors that belong to the first quality classification Class_1 with the limitation DET of defect management. If the number EC_1 is not smaller than the limitation DET, the defect sector determination unit 750 determines the disc drive as a defective disc drive. This case corresponds to the case where the number of defective data sectors exceeds the limitation DET of defect management according to the absolute evaluation criterion and thus, the disc drive is determined as a defective disc drive.

If the number EC_1 is smaller than the limitation DET, the defect sector determination unit 750 compares the number EC_2 of data sectors that belong to the second quality classification Class_2 with the limitation DET of defect management. As a result of the comparison, if the number EC_2 is not smaller than the limitation DET, the data sectors that belong to the first quality classification Class_1 are determined as defective data sectors.

If the number EC_2 is smaller than the limitation DET, the number EC_3 of data sectors that belong to the third quality classification Class_3 is compared with the limitation DET of defect management. As a result of the comparison, if the number EC_3 is not smaller than the limitation DET, the data sectors that belong to the second quality classification Class_2 are determined as defective data sectors. If the number EC_3 is smaller than the limitation DET, the data sectors that belong to the third quality classification Class_3 are determined as defective data sectors.

As described above, the defect sector determination unit 750 compares the number of data sectors according to quality classifications with the limitation DET of defect management. The defect sector determination unit 750 thereby identifies data sectors that belong to quality classifications including the number of data sectors that do not exceed the limitation DET of defect management and are closest to the limitation DET of defect management as defective data sectors.

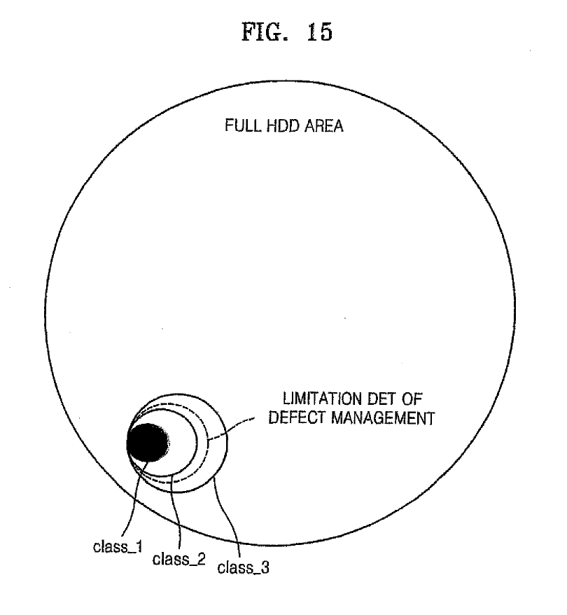

FIG. 15 illustrates the concept of defect management by classifying the quality of defective data sectors for managing defects of a recording medium according to an embodiment of the inventive concept. Referring to FIG. 15, the storage capacity of each of the data sectors that belong to the first quality classification Class_1, the second quality classification Class_2, and the third quality classification Class_3 in the entire storage area of the data storage device is shown. The black area represents the capacity of defective data sectors according to the absolute evaluation criterion. The range of limitation means a maximum defect processing capacity that is allowable in the data storage device according to the limitation DET of defect management.

When the storage capacity of each of the data sectors according to quality classifications is calculated as in FIG. 15, a quality classification including the number of data sectors that do not exceed the range of limitation and are closest to the range of limitation is the second quality classification Class_2. Thus, the data sectors that belong to the second quality classification Class_2 are determined as defective data sectors. Since the first quality classification Class_1 is included in the second quality classification Class_2, data sectors that belong to the first quality classification Class_1 are likewise determined as defective data sectors.

The defect controller 760 reads information about data sectors that belong to the quality classification determined as defective data sectors from the sector classification information storage unit 730 and writes the information to a defect list. The defect controller 760 generates a control signal for screen processing of the data sectors, so that logical block addresses are not allocated to the data sectors determined as defective. Therefore, when the data storage device processes the data sectors as defective according to the control signal, the information about the data sectors that belong to the quality classification determined as defective cannot be written to or read from. For reference, defect list information may be stored in the disc 12 or the ROM 120.

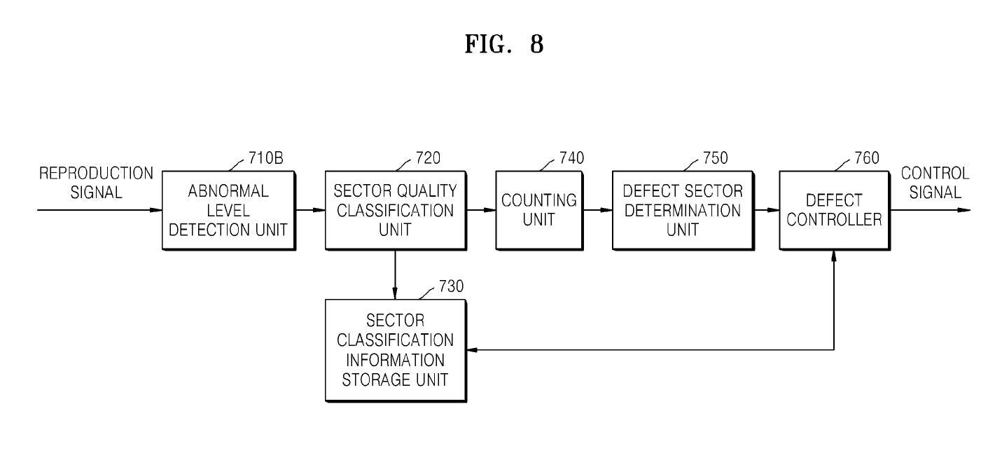

FIG. 8 is a block diagram of an apparatus for managing defects of a recording medium, according to another embodiment of the inventive concept. Referring to FIG. 8, the apparatus for managing defects of a recording medium may be included in the processor 110 of the data storage device of FIG. 1 or the controller 430 of FIG. 4, and/or may also be a separate circuit, according to design requirements, application specific implementations and other circumstances. In an embodiment of the inventive concept, the apparatus for managing defects of a recording medium, as illustrated in FIG. 8, is designed to be included in the processor 110 or the controller 430.

Referring to FIG. 8, the apparatus for managing defects of a recording medium, according to the present embodiment of the inventive concept, includes an abnormal level detection unit 710B, a sector quality classification unit 720, a sector classification information storage unit 730, a counting unit 740, a defect sector determination unit 750, and a defect controller 760.

After a test signal is written to the recording medium for detecting defects of the recording medium, data processing for the defect management described below is performed. The test signal may be a signal having a 2T pattern, for example.

The abnormal level detection unit 710B receives a reproduction signal reproduced from the recording medium in which the test signal is written, detects a magnitude of the reproduction signal, and calculates the number of detection events in which the detected magnitude of the reproduction signal is less than a threshold value in each data sector. The detected magnitude of the reproduction signal may refer to a peak-to-peak value of a signal waveform, for example. The threshold value is determined as a size of a waveform at which the reproduction signal cannot be processed normally by the data storage device. For example, the reproduction signal received by the abnormal level detection unit 710B may be set to a signal that is continually amplified by the VGA (not shown) after being processed by the preamplifier 410, shown in FIG. 4.

The sector quality classification unit 720, the sector classification information storage unit 730, the counting unit 740, the defect sector determination unit 750, and the defect controller 760 illustrated in FIG. 8 are substantially the same as those illustrated in FIG. 7, respectively. Thus, the descriptions will not be repeated here.

However, the sector quality classification unit 720 of FIG. 7 classifies the quality of data sectors using the number of error-corrected ECC symbols calculated by the ECC processor 710A for each data sector, whereas the sector quality classification unit 720 of FIG. 8 classifies the quality of data sectors using the number of detection events calculated by the abnormal level detection unit 710B for each data sector. The sector quality classification process is performed in the same manner as in the sector quality classification unit 720 of FIG. 7.

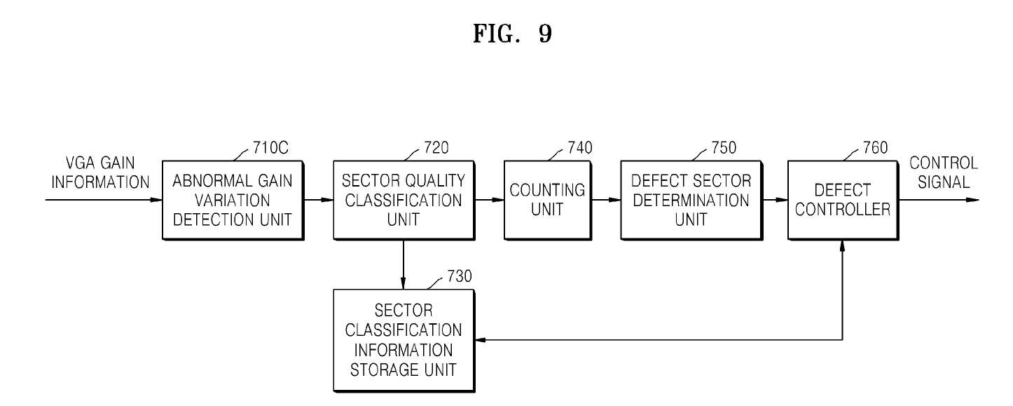

FIG. 9 is a block diagram of an apparatus for managing defects of a recording medium, according to another embodiment of the inventive concept. Referring to FIG. 9, the apparatus for managing defects of a recording medium may be included in the processor 110 of the data storage device of FIG. 1 or the controller 430 of FIG. 4, and/or may also be a separate circuit, according to design requirements, application specific implementations and other circumstances. In an embodiment of the inventive concept, the apparatus for managing defects of a recording medium, as illustrated in FIG. 9, is designed to be included in the processor 110 or the controller 430.

Referring to FIG. 9, the apparatus for managing defects of a recording medium, according to the present embodiment of the inventive concept, includes an abnormal gain variation detection unit 710C, a sector quality classification unit 720, a sector classification information storage unit 730, a counting unit 740, a defect sector determination unit 750, and a defect controller 760.

After a test signal is written to the recording medium to detect defects of the recording medium, data processing for the defect management described below is performed. The test signal may be a signal having a 2T pattern, for example.

The abnormal gain variation detection unit 710C receives VGA gain information from a VGA (not shown), and detects the amount of gain variation from the VGA gain information by which a gain of a signal reproduced from the recording medium in which the test signal is written is varied in order to amplify the signal to a desired level. The abnormal gain variation detection unit 710C calculates the number of detection events, which occur when the amount of gain variation detected by the abnormal gain variation detection unit 710C exceeds a threshold value in the data sector.

The sector quality classification unit 720, the sector classification information storage unit 730, the counting unit 740, the defect sector determination unit 750, and the defect controller 760 illustrated in FIG. 9 are substantially the same as those illustrated in FIG. 7, respectively. Thus, the descriptions will not be repeated here.

However, the sector quality classification unit 720 of FIG. 7 classifies the quality of data sectors using the number of error-corrected ECC symbols calculated by the ECC processor 710A for each data sector, whereas the sector quality classification unit 720 of FIG. 9 classifies the quality of data sectors using the number of detection events generated by the abnormal gain variation detection unit 710C for each data sector. The sector quality classification processing is performed in the same manner as in the sector quality classification unit 720 of FIG. 7.

The methods of managing defects of a recording medium, performed by the processor 110 of the data storage device of FIG. 1 or by the controller 430 of FIG. 4, according to embodiments of the inventive concept, are described with reference to FIGS. 10 through 13.

FIG. 10 is a flowchart illustrating a method of managing defects of a recording medium, according to an embodiment of the inventive concept. Referring to FIG. 10, in Operation S10, the processor 110 or the controller 430 performs a quality test for data sectors of the recording medium. In this regard, the quality test may include detecting the number of error-corrected ECC symbols, indicating that errors occurred and have been corrected, from ECC symbols when data is read from the recording medium in which a test signal is written in each data sector, as discussed above with reference to FIG. 7. Alternatively, the quality test may include detecting the number of detection events in which the detected magnitude of a reproduction signal from the recording medium, in which the test signal is written, is less than a threshold value in each data sector, as discussed above with reference to FIG. 8. Alternatively, the quality test may include detecting the number of detection events in which the amount of gain variation from VGA gain information for varying a gain of a reproduction signal from the recording medium in which the test signal is written, exceeds a threshold value in each data sector, as discussed above with reference to FIG. 9. The test signal may be a signal having a 2T pattern or various signals having other patterns. Of course, the quality test is not limited to the above-described quality tests, and may include other quality tests without departing from the scope of the present teachings.

In Operation S20, the processor 110 or the controller 430 classifies the quality of data sectors by applying evaluation criteria to the result of the quality test for each data sector. The evaluation criteria may include an absolute evaluation criterion for determining defective data sectors having the lowest quality, and a relative evaluation criterion for determining potentially defective data sectors including defective data sectors. The relative evaluation criterion may be subdivided into one or more criteria. Classifying the quality of data sectors has been described above with respect to the sector quality classification unit 720 of FIG. 7, and thus the description will not be repeated here.

In Operation S30, the processor 110 or the controller 430 selects a quality classification to be processed as a defect in consideration of the number of data sectors included in each quality classification. The number of data sectors included in the quality classifications is compared with a limitation DET of defect management. The quality classification including the number of data sectors that do not exceed the limitation DET of defect management, and are closest to the limitation DET of defect management, is selected as the quality classification to be processed as defect.

In Operation S40, the processor 110 or the controller 430 processes data sectors included in the quality classification selected as the quality classification to be processed as a defect. Screen processing is performed on the data sectors, so that logical block addresses are not allocated to the data sectors included in the quality classification selected as the quality classification to be processed as a defect.

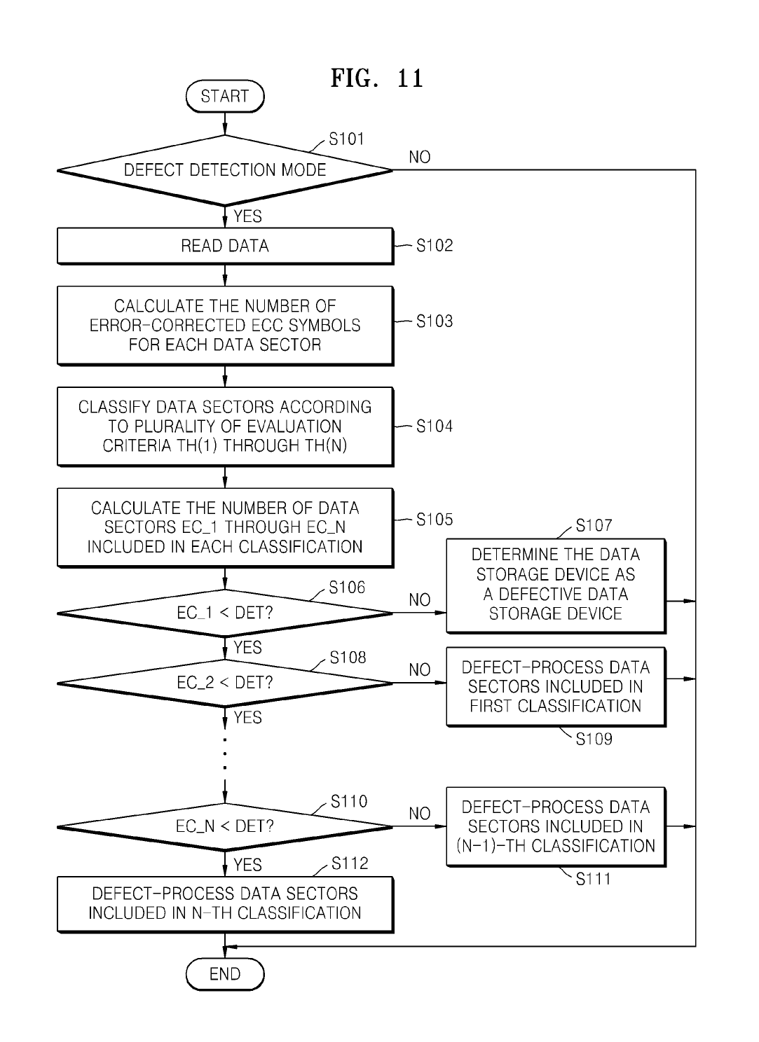

The method of managing defects of a recording medium, by which a quality test of data sectors using an ECC test is carried out, according to another embodiment of the inventive concept, is described with reference to FIG. 11.

FIG. 11 is a flowchart illustrating a method of managing defects of a recording medium, according to another embodiment of the inventive concept. Referring to FIG. 11, test information is first written to the recording medium to detect a defect. In Operation S101, it is determined whether the data storage device is switched to a defect detection mode.

When it is determined that the data storage device is switched to the defect detection mode in Operation S101, a data read mode is executed and data is read from the recording medium in Operation S102. When it is determined that the data storage device is not switched to the defect detection mode in Operation S101, the method of managing defects of a recording medium ends.

In Operation S103, the number of error-corrected ECC symbols according to data sectors is calculated by decoding using an ECC on the read data. For example, error-corrected ECC symbols, indicating that errors occurred and have been corrected, are detected from ECC symbols included in information read from the recording medium in which test information is written, in track units by performing an ECC scan operation. Information about the number of error-corrected ECC symbols for each data sector is generated.

In Operation S104, the quality of data sectors is classified according to evaluation criteria, indicated by corresponding threshold values TH(1) through to TH(N) based on the number of error-corrected ECC symbols. The evaluation criteria include an absolute evaluation criterion for determining defective data sectors having the lowest quality and a relative evaluation criterion for determining potentially defective data sectors including defective data sectors. The relative evaluation criterion may be subdivided into one or more criteria.

For example, a data sector in which the number of error-corrected ECC symbols exceeds a first threshold value TH(1), which is an absolute evaluation criterion, is determined to be in the first quality classification Class_1. A data sector in which the number of error-corrected ECC symbols exceeds a second threshold value TH(2), which is a first relative evaluation criterion, is determined to be in the second quality classification Class_2. Likewise, a data sector in which the number of error-corrected ECC symbols exceeds an N-th threshold value TH(N), which is an (N−1)^{th} relative evaluation criterion, is determined to be in N^{th} quality classification Class_N. In this regard, the sizes of the first, second, . . . , and N^{th} threshold values have the relationship of TH(1)>TH(2)> . . . >TH(N).

In Operation S105, the number EC_1 through to EC_N of data sectors included in each quality classification in the entire storage area of the recording medium is calculated. For example, the number EC_1 of data sectors belong to the first quality classification Class_1, the number EC_2 of data sectors belong to the second quality classification Class_2, and the number EC_N of data sectors belong to the N^{th} quality classification Class_N. In this regard, EC_1=EC_2=EC_3 . . . =EC_N.

In Operation S106, the number EC_1 of data sectors that belong to the first quality classification Class_1, which is the lowest quality classification, is compared with a limitation DET of defect management. The limitation DET of defect management is the maximum number of defective data sectors allowed in the data storage device.

When it is determined that the number EC_1 is not less than the limitation DET as a result of the comparison in Operation S106, the data storage device is determined to be defective in Operation S107. This corresponds to the case in which the number of defective data sectors exceeds the limitation DET of defect management according to the absolute evaluation criterion, and thus the data storage device is determined to be a defective data storage device.

When it is determined that the number EC_1 is less than the limitation DET as a result of the comparison in Operation S106, the number EC_2 of data sectors that belong to the second quality classification Class_2 is compared with the limitation DET in Operation S108. As a result of the comparison in Operation S108, when it is determined that the number EC_2 is not less than the limitation DET, the data sectors that belong to the first quality classification Class_1 are determined as defective data sectors and are defect-processed in Operation S109.

When it is determined that the number EC_2 is less than the limitation DET as a result of the comparison in Operation S108, the number of data sectors that belong to a corresponding quality classification is compared with the limitation DET of defect management, while sequentially increasing the applicable quality classifications. The defective data sectors are determined accordingly, and defect processing may be performed when the number of data sectors that belong to the corresponding quality classification is not less than the limitation DET.

As a result of comparing the number of data sectors belonging to sequentially increasing quality classifications to the limitation DET in this manner, when the number EC_N−1 is less than the limitation DET, the number EC_N of data sectors that belong to the N^{th} quality classification Class_N is compared with the limitation DET of defect management in Operation S110.

When it is determined that the number EC_N is not less than the limitation DET as a result of the comparison in Operation S110, data sectors that belong to the (N−1)^{th} quality classification Class_N−1 are determined as defective data sectors and are defect-processed in Operation S111. When it is determined that the number EC_N is less than the limitation DET as a result of the comparison in Operation S110, data sectors that belong to the N^{th} quality classification Class_N are determined as defective data sectors and are defect-processed in Operation S112.

As described above, the number of data sectors in each quality classification is compared with the limitation DET of defect management. Accordingly, the quality classification that includes the number of data sectors closest to but not exceeding the limitation DET of defect management is selected as the quality classification to be processed as a defect.

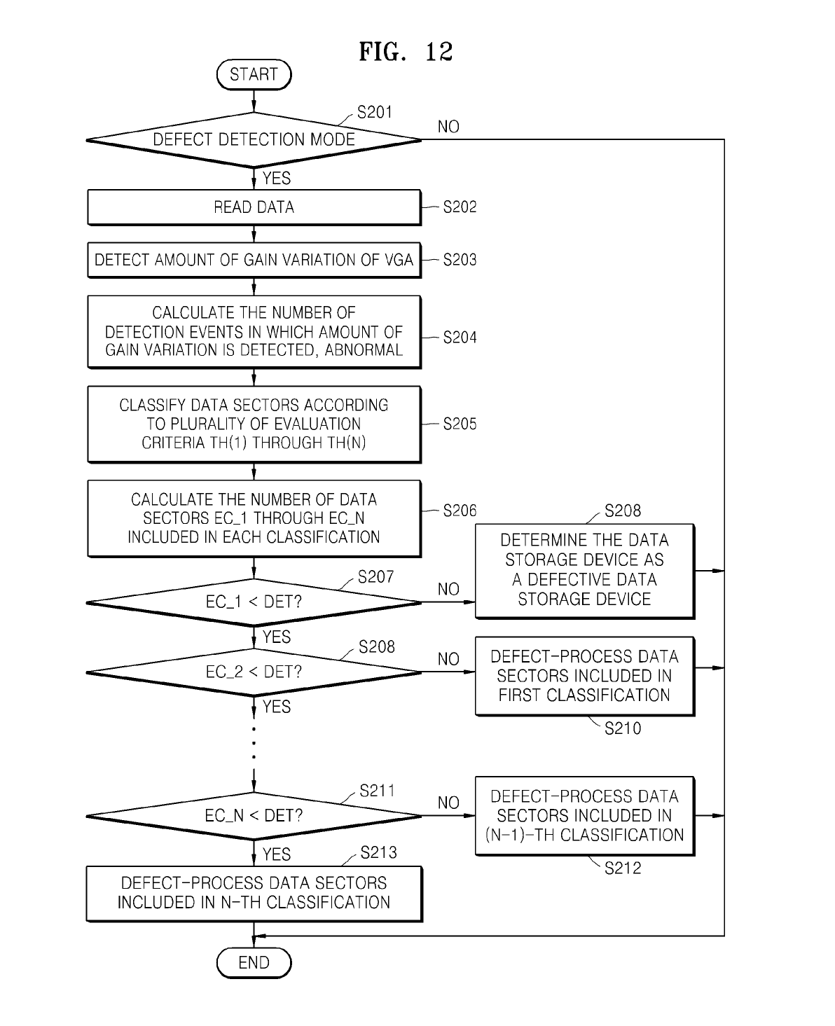

The method of managing defects of a recording medium, by which a quality test of data sectors is performed using a test of the amount of gain variation of a VGA for amplifying a signal detected from the recording medium in which a test signal is written, according to another embodiment of the inventive concept, is described with reference to FIG. 12.

FIG. 12 is a flowchart illustrating a method of managing defects of a recording medium, according to another embodiment of the inventive concept. Referring to FIG. 12, the test signal is first written to the recording medium to detect a defect. For example, the test signal may be a 2T signal. In Operation S201, it is determined whether the data storage device is switched to a defect detection mode.

When it is determined that the data storage device is switched to the defect detection mode in Operation S201, a data read mode is executed and a signal is read from the recording medium and reproduced in Operation S202. When it is determined that the data storage device is not switched to the defect detection mode in Operation S201, the method of managing defects of a recording medium ends.

In Operation S203, the amount of gain variation of a VGA is detected. The gain variation is for varying a gain of a signal, reproduced from the recording medium in which the test signal is written, to amplify the signal to a desired level. The amount of gain variation may be detected by calculating a difference between an average value of gains of the VGA in a previous sample of a reproduction signal and an average value of gains of the VGA in the current sample of the reproduction signal. A criterion of gain variation is set to the average value of gains of the VGA in the previous sample of the reproduction signal because a determination error due to disturbances, such as spike noise and the like, may be reduced and a defect area may be accurately detected.

In Operation S204, the number of detection events is calculated in each data sector. The detection events occur when the detected amount of gain variation in the data sector exceeds a threshold value.

In Operation S205, the quality of data sectors is classified according to evaluation criteria, indicated by corresponding threshold values TH(1) through TH(N) based on the number of detection events, in which the amount of gain variation in the data sector exceeds the threshold value. In comparison, in Operation S104 of FIG. 11, the quality of data sectors is classified using the number of error-corrected ECC symbols, whereas in Operation 205 of FIG. 12, the quality of data sectors is classified using the number of detection events, in which the amount of gain variation exceeds the threshold value for each data sector. The sector quality classification process is performed in the same manner as in Operation S104 of FIG. 11.

Operations S206 through S213 are the same as Operations S105 through S112 of FIG. 11, respectively, and thus the corresponding descriptions will not be repeated here.

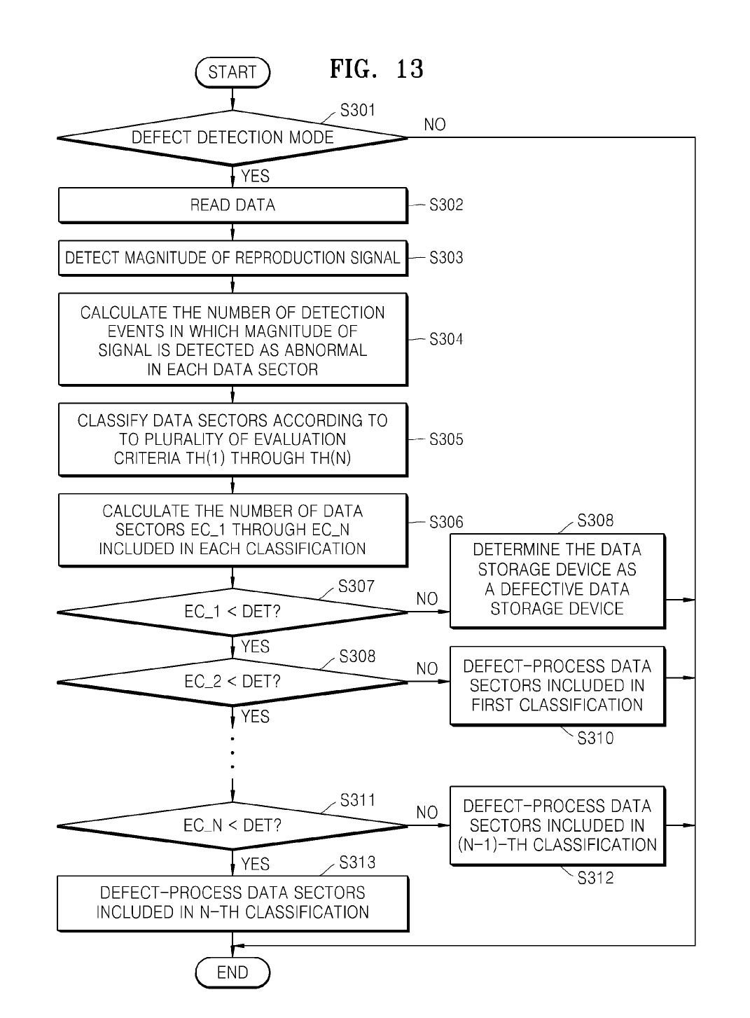

The method of managing defects of a recording medium, by which a quality test of data sectors is performed using a test of the magnitude of a signal reproduced from the recording medium in which a test signal is written, according to another embodiment of the inventive concept, is described with reference to FIG. 13.

FIG. 13 is a flowchart illustrating a method of managing defects of a recording medium, according to another embodiment of the inventive concept. Referring to FIG. 13, the test signal is first written to the recording medium to detect a defect. For example, the test signal may be a 2T signal. In Operation S301, it is determined whether the data storage device is switched to a defect detection mode.

When it is determined that the data storage device is switched to the defect detection mode in Operation S301, a data read mode is executed and a signal is detected from the recording medium and is reproduced in Operation S302. When it is determined that the data storage device is not switched to the defect detection mode in Operation S301, the method of managing defects of a recording medium ends.

In Operation S303, the magnitude of the reproduction signal, reproduced from the recording medium in which the test signal is written, is detected. In this regard, the magnitude of the reproduction signal may be a peak-to-peak value of a signal waveform, for example.

In Operation S304, the number of data sectors in which the magnitude of the reproduction signal is detected to be abnormal is calculated in each data sector. In particular, the number of detection events, in which the magnitude of the reproduction signal is less than a threshold value, is calculated in each data sector. The threshold value is determined as a size of a waveform at which the restoration signal cannot be normally processed by the data storage device.

In Operation S305, the quality of data sectors is classified according to evaluation criteria, indicated by threshold values TH(1) through TH(N) based on the number of detection events, in which the magnitude of the reproduction signal is less than the threshold value for each data sector. In comparison, in Operation S104 of FIG. 11, the quality of data sectors is classified using the number of ECC correction symbols, whereas in Operation 305 of FIG. 13, the quality of data sectors is classified using the number of detection events, in which the magnitude of the reproduction signal is less than the threshold value for each data sector. The sector quality classification process is performed in the same manner as in Operation S104 of FIG. 11.

Operations S306 through S313 are the same as Operations S105 through S112 of FIG. 11, respectively, and thus the corresponding descriptions will not be repeated here.

As described above, the number of data sectors in each quality classification is compared with the limitation DET of defect management. Accordingly, the quality classification that includes the number of data sectors closest to but not exceeding the limitation DET of defect management is selected as the quality classification to be processed as a defect.

Thus, data sectors having a high probability that a defect may occur, as well as defective data sectors, can be detected and processed as defects in a range of the defect management limitation that is allowable in the data storage device.

The inventive concept may be implemented by a method, an apparatus, a system or the like. When the inventive concept is implemented by software, elements of the inventive concept are code segments for executing an essential work. Programs or code segments may be stored in a computer readable recording medium, such as such an electrically programmable read-only memory (EPROM), an electrically erasable and programmable read only memory (EEPROM), a CD, a DVD, a universal serial bus (USE) drive, or the like.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A method of managing defects of a recording medium of a data storage device, the method comprising:
performing a quality test related to occurrence of errors for each data sector in the recording medium;
classifying a quality of each data sector according to a plurality of evaluation criteria corresponding to a plurality of quality classifications based on the quality test;
determining a number of data sectors in each quality classification of the plurality of quality classifications; and
defect-processing the data sectors in the quality classifications that range from a lowest quality classification to a highest quality classification within a defect management limitation of the data storage device.

2. The method of claim 1, wherein the quality test comprises detecting a number of error-corrected error correction code (ECC) symbols, indicating that errors occurred and have been corrected, from ECC symbols when data is read from the recording medium in which a test signal is written in each data sector.

3. The method of claim 1, wherein the quality test comprises detecting a number of detection events, in which a magnitude of a signal reproduced from the recording medium on which a test signal is written is less than a threshold value, in each data sector.

4. The method of claim 3, wherein the signal reproduced from the recording medium comprises a signal indicating an amount by which the signal is amplified by a variable gain amplifier (VGA).

5. The method of claim 1, wherein the quality test comprises detecting the number of detection events, in which an amount of gain variation of a VGA for amplifying the signal detected from the recording medium in which a test signal is written exceeds a threshold value, in each data sector.

6. The method of claim 5, wherein the test signal comprises a signal having a 2T pattern.

7. The method of claim 1, wherein the plurality of evaluation criteria comprise an evaluation criterion for determining defective data sectors having the lowest quality classification and at least one evaluation criterion for determining potentially defective data sectors.

8. The method of claim 1, further comprising:
determining the data storage device is a defective data storage device when a number of data sectors belonging to the lowest quality classification exceeds the defect management limitation of the data storage device.

9. The method of claim 1, wherein the defect-processing the data sectors comprises:
comparing the number of data sectors belonging to a corresponding quality classification in a sequence of quality classifications with the defect management limitation;
selecting a quality classification comprising the number of data sectors that do not exceed the defect management limitation and are closest to the defect management limitation; and
defect-processing the data sectors belonging to the selected quality classification.

10. The method of claim 9, wherein the defect-processing of the data sectors belonging to the selected quality classification comprises screen processing of data sectors so that logical block addresses are not allocated to the data sectors belonging to the selected quality classification.

11. A data storage device comprising:
a recording medium in which information is stored, the recording medium comprising a plurality of data sectors;
a media interface for writing to or reading from the recording medium by accessing the recording medium; and
a processor for performing a quality test related to occurrence of errors for each data sector in the recording medium by controlling the media interface, classifying a quality of each data sector according to a plurality of evaluation criteria corresponding to a plurality of quality classifications based on the quality test, determining a number of data sectors in each quality classification of the plurality of quality classifications, and defect-processing the data sectors of the quality classifications that range from a lowest quality classification to a highest quality classification within a defect management limitation of the data storage device.

12. The data storage device of claim 11, wherein the quality test comprises detecting a number of error-corrected error correction code (ECC) symbols, indicating that errors occurred and have been corrected, from ECC symbols when data is read from the recording medium in which a test signal is written in each data sector.

13. The data storage device of claim 11, wherein the plurality of evaluation criteria comprise an evaluation criterion for determining defective data sectors having the lowest quality classification and at least one evaluation criterion for determining potentially defective data sectors comprising defective data sectors.

14. The data storage device of claim 11, wherein, when the number of data sectors belonging to the lowest quality classification exceeds the defect management limitation, the processor determines the data storage device to be a defective data storage device.

15. The data storage device of claim 11, wherein the processor compares the number of data sectors belonging to a corresponding quality classification in a sequence of quality classifications with the defect management limitation, selects a quality classification comprising the number of data sectors that do not exceed the defect management limitation and are closest to the defect management limitation, and determines that the data sectors belonging to the selected quality classification are defective.

16. The data storage device of claim 11, wherein the processor comprises:
an error correction code (ECC) processing unit for detecting error-corrected ECC symbols, indicating that errors occurred and have been corrected, from ECC symbols belonging to information read from the recording medium and generating information about the number of error-corrected ECC symbols for each data sector;
a sector quality classification unit for classifying the quality of data sectors according to the plurality of evaluation criteria based on the information about the number of error-corrected ECC symbols for each data sector;
a counting unit for determining the number of data sectors in each quality classification of the plurality of quality classifications based on quality classifications evaluated by the sector quality classification unit;
a defect sector determination unit for comparing the number of data sectors in each of the quality classifications with the defect management limitation and determining as defective data sectors belonging to a quality classification comprising the number of data sectors that do not exceed the defect management limitation and are closest to the defect management limitation; and
a defect controller for controlling defects so that logical block addresses are not allocated to the defective data sectors.

17. The data storage device of claim 11, wherein the processor comprises:
an abnormal level detection unit for detecting a magnitude of a signal reproduced from the recording medium and calculating a number of detection events in which the magnitude of the detected signal is less than a threshold value in each data sector;
a sector quality classification unit for classifying the quality of data sectors according to the plurality of evaluation criteria based on the number of detection events calculated by the abnormal level detection unit;
a counting unit for determining the number of data sectors in each quality classification of the plurality of quality classifications based on quality classifications evaluated by the sector quality classification unit;
a defect sector determination unit for comparing the number of data sectors in each of the quality classifications with the defect management limitation and determining as defective data sectors belonging to a quality classification comprising the number of data sectors that do not exceed the defect management limitation and are closest to the defect management limitation; and
a defect controller for controlling defects so that logical block addresses are not allocated to the defective data sectors.

18. The data storage device of claim 11, wherein the processor comprises:
an abnormal gain variation detection unit for detecting an amount of gain variation of a variable gain amplifier (VGA) for varying a gain of a signal reproduced from the recording medium to amplify the signal to a desired level and calculating a number of detection events in which the amount of gain variation detected by the abnormal gain variation detection unit exceeds a threshold value in each data sector;
a sector quality classification unit for classifying the quality of data sectors according to the plurality of evaluation criteria based on the number of detection events calculated by the abnormal gain variation detection unit;
a counting unit for determining the number of data sectors in each quality classification of the plurality of quality classifications based on quality classifications evaluated by the sector quality classification unit;
a defect sector determination unit for comparing the number of data sectors in each of the quality classifications with the defect management limitation and determining as defective data sectors belonging to a quality classification comprising the number of data sectors that do not exceed the defect management limitation and are closest to the defect management limitation; and
a defect controller for controlling defects so that logical block addresses are not allocated to the defective data sectors.

19. The data storage device of claim 11, wherein the recording medium comprises a disc.

20. A computer readable storage medium storing program code for managing defects of a recording medium, the computer readable storage medium comprising:
performing code for performing a quality test related to occurrence of errors for each data sector in the recording medium;
classifying code for classifying a quality of each data sector according to a plurality of evaluation criteria corresponding to a plurality of quality classifications based on the quality test;
determining code for determining a number of data sectors in each quality classification of the plurality of quality classifications; and
defect-processing code for defect-processing the data sectors the quality classifications that range from a lowest quality classification to a highest quality classification within a defect management limitation of the data storage device.
